(19) United States
(12) Patent Application Publication
(10) Pub. No.: US 2023/0219569 A1
(43) Pub. Date: Jul. 13, 2023

(54) PERSONALIZED VEHICLE OPERATION FOR AUTONOMOUS DRIVING WITH INVERSE REINFORCEMENT LEARNING

(71) Applicant: TOYOTA MOTOR ENGINEERING & MANUFACTURING NORTH AMERICA, INC., Plano, TX (US)

(72) Inventors: ZHOUQIAO ZHAO, Riverside, CA (US); ZIRAN WANG, San Jose, CA (US); ROHIT GUPTA, Santa Clara, CA (US); KYUNGTAE HAN, Palo Alto, CA (US); PRASHANT TIWARI, Santa Clara, CA (US)

(21) Appl. No.: 17/572,486

(22) Filed: Jan. 10, 2022

(51) Int. Cl. B60W 30/16; B60W 60/00; B60W 40/105; B60W 40/06; B60W 40/04

(52) U.S. Cl. CPC B60W 30/16; B60W 60/001; B60W 40/105; B60W 40/06; B60W 40/04; B60W 2554/402; B60W 2554/80; B60W 2554/4046

(57) ABSTRACT

Systems and methods are provided for implementing personalized adaptive cruise control techniques in connection with, but not necessarily, autonomous and semi-autonomous vehicles. In accordance with one embodiment, a method comprises receiving first vehicle operating data and associated first environmental data of a plurality of vehicles; classifying the first vehicle operating data and the first environmental data into a plurality of driver type classifications; training a control policy model for each driver type classification based on the first vehicle operating data and the first environmental data; receiving a real-time classification of a target vehicle based on second vehicle operating data and associated second environmental data of the target vehicle; and output a trained control policy model the to target vehicle based on the real-time classification of the vehicle, wherein the target vehicle is controlled according to the trained control policy model.

### TECHNICAL FIELD

The present disclosure relates generally to adaptive cruise control in a vehicle, and in particular, some implementations may relate to adaptive cruise control personalized based on driver type classifications and environmental factors.

### DESCRIPTION OF RELATED ART

Automated driving systems are gradually replacing manual, human driving maneuvers in various vehicle control applications, such as adaptive cruise control (ACC) and lane-keeping systems. Driving automation is also predicted to play an increasingly essential role in daily driving. One challenge in implementing automated driving systems is that such systems based on expert or predefined control strategies differ from human driving preferences and behaviors. Drivers may become uncomfortable with the autonomous control imparted by the automated systems and cease using them.

For example, ACC systems, based on information from onboard sensors (e.g., radar, lasers, cameras), automatically adjusts the speed of a vehicle to maintain a following distance from a lead vehicle traveling ahead of the vehicle in the same lane of traffic. Expert or predefined following distances maintained by the ACC system may differ from vehicle-following behavior of a driver. For example, some drivers may prefer to follow at greater distance, whereas other more aggressive drivers may prefer to follow more closely. It is, therefore, difficult to design an ACC system that satisfies drivers' diverse personal vehicle-following preferences.

### BRIEF SUMMARY OF THE DISCLOSURE

According to various embodiments of the disclosed technology systems and methods for personalized adaptive cruise control are provided.

In accordance with some embodiments, a method is provided that comprises receiving first vehicle operating data and associated first environmental data of a plurality of vehicles; classifying the first vehicle operating data and the first environmental data into a plurality of driver type classifications; training a control policy model for each driver type classification based on the first vehicle operating data and the first environmental data; receiving a real-time classification of a target vehicle based on second vehicle operating data and associated second environmental data of the target vehicle; and output a trained control policy model the to target vehicle based on the real-time classification of the vehicle, wherein the target vehicle is controlled according to the trained control policy model.

In another aspect, as system is provided that comprises a memory configured to store machine readable instructions and one or more processors that are configured to execute the machine readable instructions stored in the memory for performing a method. The method comprises receive first vehicle following data and associated first environmental data of a plurality of vehicles; classify the first vehicle following data and the first environmental data into a plurality of driver type classifications; train a cruise control policy model for each driver type classification based on the first vehicle following data and the first environmental data; receive a real-time classification of a target vehicle based on second vehicle following data and associated second environmental data of a target vehicle; and output a trained cruise control policy model to the target vehicle based on the real-time classification of the vehicle, wherein a following distance between the target vehicle and a lead vehicle is controlled according to the trained cruise control policy model.

In another aspect, a vehicle is provided that comprises a plurality of sensors, a memory configured to store machine readable instructions, and one or more processors that are configured to execute machine readable instructions stored in the memory for performing a method. The method comprises collect, from the plurality of sensors, vehicle operating data and associated environmental data of a plurality of vehicles; classify, in real-time, the vehicle operating data and the environmental data into a driver type classification; transmit the real-time driver type classification to a cloud server; receive, from the cloud server, a trained control policy model based on the real-time driver type classification; calculate a control policy from the control policy model based on the vehicle operating data; and control driving of the vehicle based on the calculated control policy.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic illustration of an example personalized adaptive cruise control system in which a vehicle control is performed in accordance with various embodiments disclosed herein.

FIG. 2 is a schematic representation of an example vehicle with which embodiments of the personalized adaptive cruise control systems and methods disclosed herein may be implemented.

FIG. 3 illustrates an example architecture for personalized adaptive cruise control in accordance with embodiments of the systems and methods described herein.

FIG. 4 is an example of another architecture of a personalized adaptive cruise control system according to embodiments disclosed herein.

FIG. 5 is an example flow diagram illustrating example operations for an implementation of personalized adaptive cruise control in accordance with embodiments disclosed herein.

FIG. 6 is an example flow diagram for driver type classification using historical vehicle operating conditions and environmental factors according to embodiments disclosed herein.

FIG. 7 is an example flow diagram illustrating example operations for recovering a reward function based on a maximum entropy of inverse reinforcement learning in accordance with embodiments disclosed herein.

FIG. 8 is an example flow chart illustrating example operations for implementing personalized adaptive cruise control in accordance with various embodiments disclosed herein.

FIG. 9 is an example computing component that may be used to implement various features of embodiments described in the present disclosure.

The figures are not exhaustive and do not limit the present disclosure to the precise form disclosed.

### DETAILED DESCRIPTION

Embodiments of the systems and methods disclosed herein can personalize applications of vehicle control using vehicle operating conditions during vehicle travel. Contextual factors of an environment in which the vehicle is traveling can also be used to classify the driver of the vehicle according to a driver type. Further still, vehicle controls can be determined based on the driver type classification.

For example, for vehicle-following distances that can be maintained by an ACC system, embodiments described herein provide a personalized adaptive cruise control (P-ACC) system that learns a desired space gap (e.g., also referred to herein as a vehicle-following distance) from historical vehicle-following behaviors executed in contextual environmental conditions (e.g., weather conditions, time of day, vehicle type, and road type to name a few examples). For example, embodiments herein apply inverse reinforcement learning (IRL) to historical vehicle-following behavior and environmental factors to learn the desired vehicle-following distance corresponding to a driver type classification and environmental condition. ACC systems collect data from various on-board sensors, e.g., vehicle speed data, braking event data, vehicle acceleration data, external contextual environmental factor data, vehicle-following distance data, etc. Data collected at a plurality of vehicles, operated at various points in time, can be used to learn define driver type classifications and learn desired vehicle-following behavior for each driver type classification.

When the P-ACC system is activated for vehicle control, the P-ACC system may collect data from on-board sensors in real-time (e.g., collected for a determined time period prior to activation) to classify a driver type for the vehicle in the current environmental conditions. Embodiments herein receive a control policy model, which is trained on a cloud infrastructure (e.g., one or more cloud servers and cloud-based database resident on network). The received control policy model may correspond to the driver type classification, and may control the vehicle based on the received control policy model. The control policy model can be updated as more data is collected from various driving scenarios communicated to the cloud from various vehicles. By personalizing the vehicle-following distances according to a driver type, the rate of overriding the automated control by the driver can be decreased since the control more closely mimics the driver's preferred behavior. Whereas, as described above, automated driving systems based on expert or predefined control strategies differ from human driving preferences, and drivers may become uncomfortable by automation and override such systems.

Physics-based control policy strategies are one of the most prevalent longitudinal control methods, where the vehicle-following behavior is modeled using an ordinary differential equation (ODE). The ODE equation tries to explicitly define states and action of the driver and the interaction with the lead vehicle considering the dynamics of the following vehicle. Based on the given space gap, speed of the following vehicle, and the speed of the lead vehicle, the acceleration of the following vehicle may be calculated from the ODE. However, human driving does not strictly follow these pre-defined rules and contains subtleties that may not be fully captured by the analytical expressions.

Recently, some studies have focused on data-driven methods that learn control policy strategies from historical data. Regression-based learning methods such as Deep Neural Network (DNN) and Gaussian Mixture Model (GMM) may learn a relationship between an input (e.g., a speed of the following vehicle, vehicle-following distance, speed of the lead vehicle) and an output (e.g., acceleration). However, because these methods do not consider a temporal relation of sequential data, such methods are unable to deliver optimal results. To address this shortcoming, some research has attempted to use memory-based networks, such as the recurrent neural network (RNN) and the Long Short-Term Memory (LSTM) network, to learn sequential data. The memory-based methods may perform in terms of interpolation, but perform poorly in terms of extrapolation (e.g., inferring of future actions). Because vehicle dynamics are not taken into account for these methods, the control policy output from the above methods may not be guaranteed in the event of an unknown condition and may potentially result in a safety issue.

Accordingly, various embodiments herein provide for a control policy model based on application of a maximum entropy (Max-Ent) IRL. Such a control policy model can infer a reward function about how a driver type classification will behave during a vehicle-following maneuver. This inference can be based, for example, on data collected from on-board sensors of other vehicles of the same driver type classification. Embodiments herein may then use the control policy model to calculate an optimal control policy (e.g., acceleration) based on the recovered (e.g., inferred) reward function. The recovered reward function not only can help explain the observed demonstrations (e.g., historical data from on-board sensors) but also represent preferences of the driver if the driver were to execute the same task, opposed to directly mimicking the behavior of the observed demonstrations. As a result, the reward function is a representation of the unique driving dynamics for the driver, which the P-ACC system may utilize controlling the vehicle.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

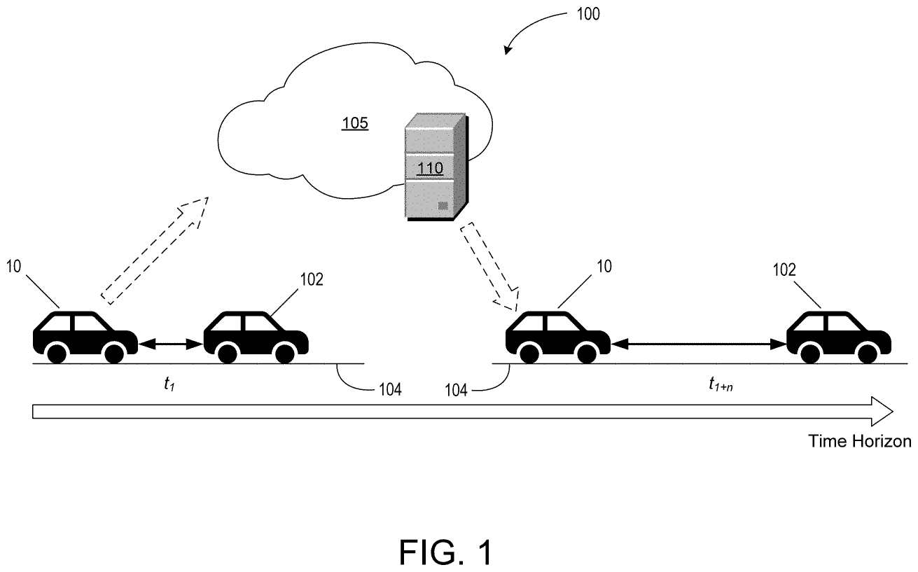

FIG. 1 illustrates an example P-ACC system 100 communicably coupled to one or more vehicles in accordance with various embodiments. FIG. 1 illustrates a plurality of vehicles 10 and 102 at a first time (t₁) and a second time (t₁₊ₙ) after the first time, while the vehicles 10 and 102 travel on roadway 104. The P-ACC system 100 receives communications from at least vehicle 10 through V2X communications.

Vehicle 10 is a vehicle exhibiting vehicle-following behavior (referred to herein as an “ego vehicle”) that is analyzed and/or controlled, in connection with the P-ACC system 100 according to embodiments disclosed herein, relative to lead vehicle. Herein, a “lead vehicle” refers to a vehicle immediately ahead of the ego vehicle traveling in the same lane of traffic as the ego vehicle, illustratively depicted din FIG. 1 as vehicle 102. In some embodiments, ego vehicle 10 includes an intelligent driving assistance system such as an Advanced Driver-Assistance System (ADAS) (not shown in FIG. 1) including the P-ACC system 100 is one aspect.

Vehicle 10 may have one or more on-board sensors (not shown in FIG. 1), e.g., vehicle operating conditions sensors, environmental sensors, etc. On-board sensors can include one or more positioning systems such as a dead-reckoning system or a global navigation satellite system (GNSS), for example a global positioning system (GPS). The on-board sensors can also include Controller-Area-Network (CAN) sensors that output, for example, speed and steering-angle data pertaining to vehicle 10. The sensors can also include one or more proximity or environment sensors that can gather data regarding nearby objects or other vehicles in the environment surrounding vehicle 10 within a detection range of the one or more environment sensors. For example, proximity sensors can be used to detect, among other things, lead vehicle 102 and to measure a vehicle-following distance between the front of ego vehicle 10 and the rear of the lead vehicle 102. Furthermore, environmental sensors may be used to detect, among other things, contextual information (also referred to herein as “environmental factors”) of the surrounding environment conditions referred to, such as, but not limited to, weather information (e.g., rain, snow, clouds, degree of visibility, such as in the case of fog, etc.), time of day information (day, night, dusk, dawn, etc.), a road type (e.g., unpaved road, paved, rural, urban, freeway, highway), a road surface condition (e.g., wet, icy, bumpy, pot holes, etc.), vehicle type of vehicle 10 (e.g., sedan, coupe, sport utility vehicle (SUV), truck, commuter vehicle such as a bus, motorcycle, boat, recreational vehicles, and other on-road or off-road vehicles), and a degree of traffic (e.g., no traffic, light traffic, congested, etc.) on the road on which the vehicle 10 is traveling.

Vehicle 10 may further have vehicle-to-everything (V2X) communications capabilities, allowing vehicle 10 to communicate with roadside equipment or infrastructure and with a network edge device, such as the cloud (e.g., one or more cloud servers 110 and cloud-based databases resident on network 105). In some examples, the vehicle 10 may receive environmental factors and/or vehicle operating conditions from roadside equipment or infrastructure over V2X communications (e.g., roadway infrastructure, road conditions or type, and so on). It should be understood that sometimes, a vehicle itself may act as a network node or edge computing device. For example, vehicle 10 may be a network edge device. The data gathered by vehicle 10, either through its own sensors, or other data sources, may be transmitted to the network edge device, such as the cloud server(s) 110. Cloud server(s) 110 may be any computational server(s), such as a server utilizing artificial intelligence (AI) systems and/or methods to model and predict and infer autonomous vehicle operation, semi-autonomous vehicle operation, and so on.

As referred to herein, AI can be described as an automated computer process(es) that can intelligently leverage data analysis for training itself for further optimizing the processes. ML can be generally considered an application of AI. AI techniques can include various approaches that are used in the area to achieve automated data analysis, such as neural, automated reasoning analysis (e.g., satisfiability modulo theories), reinforcement learning (RL), inverse reinforcement learning (IRL), and so on.

In order to achieve the semi-autonomous/autonomous modes of operation (or other manner of operating or utilizing vehicle 10), AI or ML systems and methods disclosed herein may be used to predict or implement operational commands or instructions, e.g., from an electronic control unit (ECU) of vehicle 10. Such AI or ML systems may rely on models trained using data from vehicle 10 and/or other vehicles, for example. This data, as described above, can be communicated to a network edge device, such as the cloud server(s) 110. In some embodiments, vehicle 10 may include a resident AI/ML system (not shown) that utilizes the sensed data. For example, the resident AI/ML system may ingest the sensed data, make a determination as to a driver type by classifying the sensed data as one of a plurality of driver type categories, and communicate the determination to the network edge device for retrieval of a vehicle following model that corresponds to the determined driver type.

According to various embodiments, vehicle 10 can be an autonomous. As used herein, “autonomous vehicle” can refer to a vehicle that is configured to operate in an autonomous operational mode. “Autonomous operational mode” can refer to the use of one or more computing systems of the vehicle 10 to navigate and/or maneuver vehicle 10 along a travel route with a level of input from a human driver which can vary with the operational mode. As such, vehicle 10 can have a plurality of autonomous operational modes. In some embodiments, vehicle 10 can have an unmonitored autonomous operational mode, meaning that one or more computing systems are used to maneuver vehicle 10 along a travel route fully autonomously, requiring no input or supervision required from a human driver.

Alternatively, or in addition to the above-described modes, vehicle 10 can have one or more semi-autonomous operational modes. “Semi-autonomous operational mode” can refer to a mode whereby a portion of the navigation and/or maneuvering of vehicle 10 along a travel route is performed by one or more computing systems, and a portion of the navigation and/or maneuvering of vehicle 10 along a travel route is performed by a human driver.

An example of an operational mode that may be implemented in both autonomous or semi-autonomous operational mode is when the P-ACC system 100 is activated for imparting vehicle control. In such case, the acceleration and speed of vehicle 10 can be automatically adjusted to maintain a vehicle-following distance from the lead vehicle 102 based on data received from on-board, but vehicle 10 is otherwise operated manually by a human driver. As another example, when activated, the P-ACC system 100 may maintain the vehicle-following distance and one or more other semi-autonomous operational modes (e.g., lane-keeping operational mode and the like). In semi-autonomous operational mode, driver input may activate and deactivate control of the vehicle by the P-ACC system 100, for example, through a user operated switch or other input device, upon receiving a driver input to alter the speed of the vehicle (e.g. by depressing the brake pedal to reduce the speed of the vehicle 10), and so on. For autonomous operational mode, the P-ACC system 100 may be activated along with initiating the autonomous operational mode and remain activated while the vehicle operations autonomously.

During travel, whether controlled by the P-ACC system 100 or not, vehicle 10 may receive on-board sensor information of environmental factors (e.g., weather conditions, time of day, vehicle type, and road type to name a few examples) indicative of the environment surrounding the vehicle 10. Likewise, vehicle 10 may receive on-board sensor information of vehicle operating conditions (e.g., brake pedal actuation, vehicle acceleration, vehicle speed, and vehicle-following distance to name a few).

Sensed vehicle operating conditions while the P-ACC system 100 is deactivated for vehicle control may be indicative vehicle-operating behavior of a driver. Vehicle operating conditions collected under these conditions may be referred to herein as historical vehicle operating conditions and environmental factors collected under these conditions may be referred to herein as historical environmental factors (sometimes collectively referred to herein as a historical demonstration).

When the P-ACC system 100 is activated for vehicle control, vehicle operating conditions and environmental factors collected from a preset time period prior to the activation may be referred to as current vehicle operating conditions (also sometimes referred to herein as first vehicle operating data) and current environmental factors (also sometimes referred to herein as first environmental data), respectively. For example, FIG. 1 illustrates a current time t₁ at which the vehicle collects current demonstrations as current environmental factors and current vehicle operating conditions. Time t₁ is illustrative of a single instance of sensed data by the on-board sensor information, where additional samples for the current data maybe acquired prior to and/or after time t₁ within the time period. The time period may be set as desired for the application, for example, data may be collected for 5 minutes, 10 minutes, 30 minutes, 1 hour, 1 day, 1 week, etc. prior to activation.

The current environmental factors and vehicle operating conditions (sometimes collectively referred to herein as current demonstration(s)) may be used to identify a driver type classification based on classifying the current data according to learned driver type classifications. According to some embodiments, the vehicle 10 may transmit a V2X communication, comprising the current environmental factors and current demonstrations, to the cloud server(s) 110. The cloud server(s) 110 may identify a driver type classification in real-time from the received V2X communication based on trained driver type classifications stored in the cloud-based database. In another embodiment, the vehicle 10 may classify the driver type in real-time from an electronic control unit (ECU) and transmit a V2X communication comprising the driver type classification and environmental factors to cloud server(s) 110.

The cloud server(s) 110 use the identified driver type classification to retrieve a trained control policy model from cloud-based database, which is transmitted to the vehicle 10 with a V2X communication. The cloud-based database may store driver type classifications and corresponding control policy models for access by the cloud server(s) 110. Cloud server(s) 110 may utilize artificial intelligence (AI) to model, predict, and infer autonomous/semi-autonomous vehicle operation from historical demonstrations and environmental factors. For example cloud server(s) 110 may receive historical demonstrations and environmental factors from a plurality of vehicles over respective V2X communications. Cloud server(s) 110 applies AI and machine learning (ML) algorithms to the historical data to define a plurality of driver type classifications based on clustering the historical data according to similarity. The cloud server(s) 110 may then apply an IRL algorithm on the historical data to learn control policy models for each driver type classification. For example, historical data corresponding to a given driver type classification may be input into the IRL algorithm to learn the control policy model for the given driver type classification. This process is repeated for each driver type classification. The control policy models not only can help explain the historical demonstrations in the environmental context (e.g., environmental factors) but also represent preferences of a driver of the given driver type, opposed to directly mimicking the behavior of the historical demonstrations. As a result, each control policy model is a representation of the unique driving dynamics and behavior for each driver type.

From each control policy model, the P-ACC system 100 calculates a control policy (e.g., vehicle operation inputs) for controlling the vehicle in a manner that corresponds to the vehicle driving behavior of each driver type classification. For example, in the case of vehicle-following applications, the control policy may comprise vehicle operation inputs (e.g., acceleration, brake pedal actuation, etc.) that control the vehicle-following behavior pf a similarly classified driver type in an environment condition having similar environmental factors. For example, FIG. 1 illustrates vehicle 10 receiving a V2X communication, comprising a control policy model that is based on the current data from time t¹, from cloud servers 110 at a time t₁₊ₙ after time t₁. The vehicle 10 then calculates a control policy from the control policy model, which is used as input into control vehicle 10 in a personalized manner that substantially mimics the vehicle-following behavior of a driver type corresponding to the driver type classification of the current data. According to various embodiments, the time tₙ₊₁ may be indicative of the P-ACC system 100 being activated for vehicle control, for example, user input activating the ACC system in semi-autonomous operational mode or when an autonomous operation mode is activated.

In some embodiments, the control policy may also comprise other vehicle operation inputs (e.g., steering-angle, position, etc.) to control other semi-autonomous/autonomous applications, such as lane-keeping systems and the like. Under this embodiment, along with mimicking a vehicle following behavior, the control policy is supplied so to both follow a lead vehicle according to the control policy model, as with the preceding embodiment, and steer the vehicle for a more fully autonomous operation that corresponds to the vehicle operating behaviors.

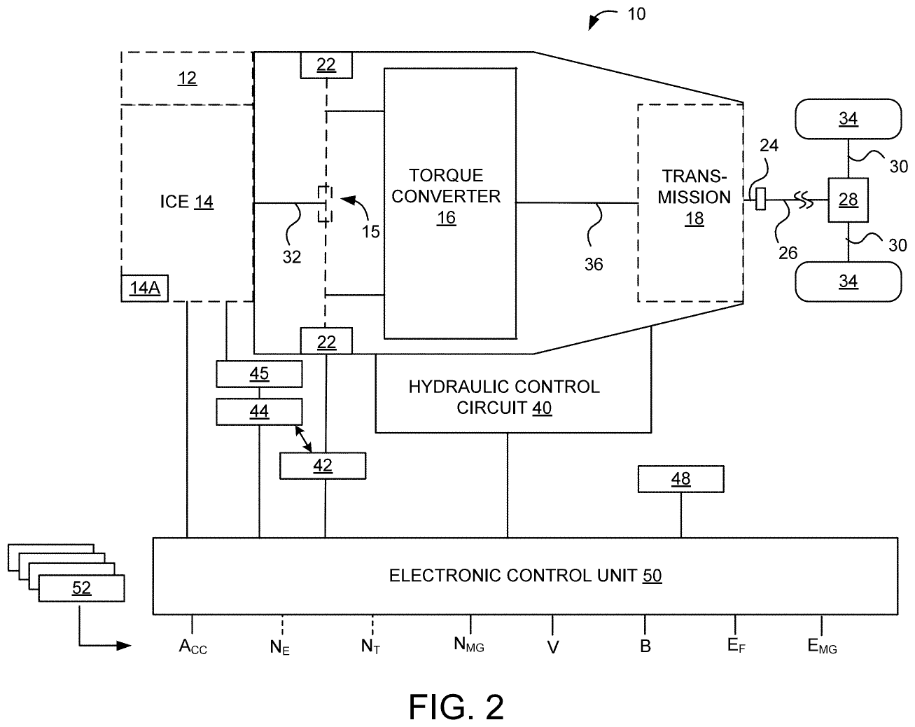

The systems and methods disclosed herein may be implemented with any of a number of different vehicles and vehicle types. For example, the systems and methods disclosed herein may be used with automobiles, trucks, motorcycles, boats, recreational vehicles, and other on-road or off-road vehicles. In addition, the principals disclosed herein may also extend to other vehicle types as well. An example hybrid electric vehicle (HEV) in which embodiments of the disclosed technology may be implemented is illustrated in FIG. 2. Although the example described with reference to FIG. 2 is a hybrid type of vehicle, the systems and methods for personalized adaptive cruise control can be implemented in other types of vehicle including gasoline- or diesel-powered vehicles, fuel-cell vehicles, electric vehicles, or other vehicles.

FIG. 2 illustrates a drive system of vehicle 10 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

Vehicle 10 may be driven/powered with either or both of engine 14 and motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be a hybrid electric vehicle (HEV) travel mode that uses engine 14 and the motor(s) 22 as the sources of motive power. In the engine-only and HEV travel modes, vehicle 10 relies on the motive force generated at least by internal combustion engine 14, and clutch 15 may be included to engage engine 14. In the EV travel mode, vehicle 10 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from electronic control unit 50, described below. Such output control can include, for example, throttle control, fuel injection control, and ignition timing control.

Motor 22 can also be used to provide motive power in vehicle 10 and is powered electrically via battery 44. Battery 44 may be implemented as one or more batteries or other power storage devices including, for example, lead-acid batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move vehicle 10 and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

Electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through inverter 42.

Torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of vehicle 10. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 10 may include electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units or using a single electronic control unit.

In the example illustrated in FIG. 2, electronic control unit 50 receives information from a plurality of sensors included in vehicle 10. For example, electronic control unit 50 may receive signals that indicate vehicle operating conditions or characteristics, or signals that can be used to derive vehicle operating conditions or characteristics. These may include, but are not limited to accelerator operation amount, ACC, a revolution speed (N_{E}) of internal combustion engine 14 (engine RPM), a rotational speed of the motor 22 (motor rotational speed), and vehicle speed (NV). These may also include torque converter 16 output (e.g., output amps indicative of motor output), brake operation amount/pressure (B), battery (i.e., the charged amount for battery 44 detected by an system on chip (SOC) sensor). Accordingly, vehicle 10 can include a plurality of sensors 52 that can be to the vehicle and provide sensed conditions to electronic control unit 50 (which, again, may be implemented as one or more individual control circuits). In one embodiment, sensors 52 may be included to detect one or more conditions directly or indirectly such as, for example, fuel efficiency, E_{F}, motor efficiency, E_{MG}, hybrid (e.g., ICE 14 and MG 12) efficiency, acceleration, ACC, etc.

Additionally, one or more sensors 52 can be configured to detect, and/or sense position and orientation changes of the vehicle 10, such as, for example, based on inertial acceleration. In one or more arrangements, electronic control unit 50 can obtain signals from vehicle sensor(s) including accelerometers, one or more gyroscopes, an inertial measurement unit (IMU), a dead-reckoning system, a global navigation satellite system (GNSS), a global positioning system (GPS), a navigation system, and/or other suitable sensors. In one or more arrangements, electronic control unit 50 receives signals from a speedometer to determine a current speed of the vehicle 10.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output. Additionally, as alluded to above, the one or more sensors 52 can be configured to detect, and/or sense in real-time. As used herein, the term “real-time” means a level of processing responsiveness that a user or system senses as sufficiently immediate for a particular process or determination to be made, or that enables the processor to keep up with some external process.

Sensors 52 may be included to detect not only vehicle conditions but also to detect external conditions as well, for example, contextual information of the surrounding environmental conditions (e.g., environmental factors). Sensors that might be used to detect external conditions can include, for example, sonar, radar, lidar or other vehicle proximity sensors, and cameras or other image sensors. Such sensors can be used to detect, for example, traffic signs indicating a current speed limit, road curvature, road type, obstacles (e.g., other surrounding vehicles and objects), space gaps with obstacles, weather, time of day, road type, road surface conditions, and a degree of traffic on the road on which the vehicle 10 is driving. and so on. Still other sensors may include those that can detect road grade. While some sensors can be used to actively detect passive environmental objects, other sensors can be included and used to detect active objects such as those objects used to implement smart roadways that may actively transmit and/or receive data or other information.

Accordingly, the one or more sensors 52 can be configured to acquire, and/or sense environmental factors. For example, environment sensors can be configured to detect, quantify and/or sense objects in at least a portion of the external environment of the vehicle 10 and/or information/data about such objects. Such objects can be stationary objects and/or dynamic objects. Further, the sensors can be configured to detect, measure, quantify and/or sense other things in the external environment of the vehicle 10, such as, for example, lane markers, signs, traffic lights, traffic signs, lane lines, crosswalks, curbs proximate the vehicle 10, off-road objects, etc.

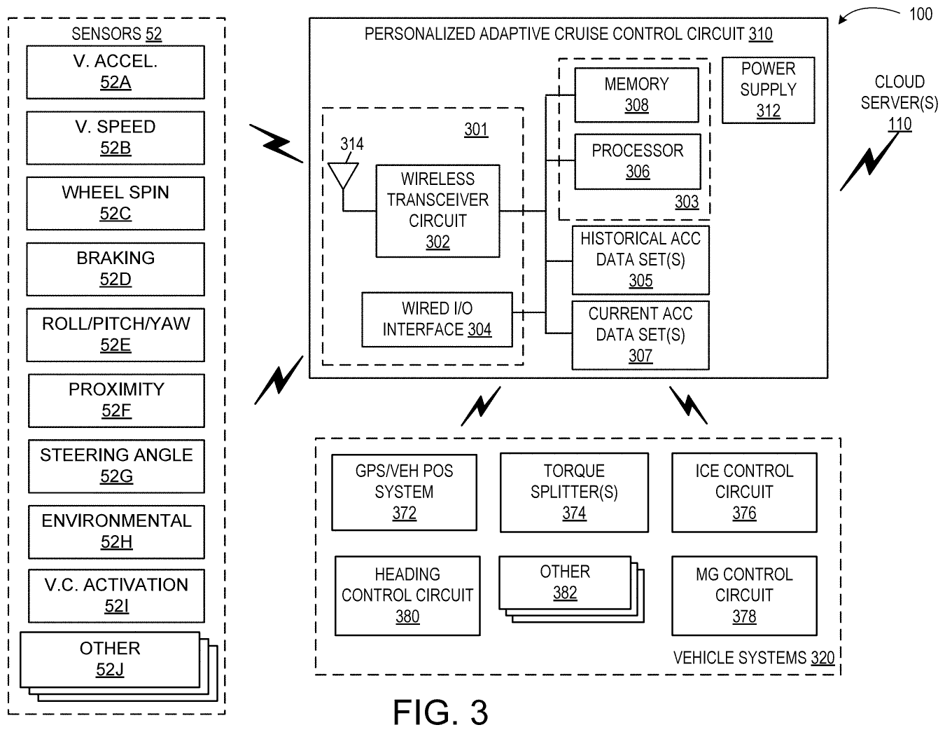

Each of the detected data discussed herein may comprise vehicle-related data. For example, sensors 52 may acquire internal vehicle information, external driving environment data, or any other information described herein. In some examples, sensors 52 may generate the vehicle-related data and/or other vehicle systems illustrated in FIG. 3 may receive the data from sensors 52 to generate the vehicle-related data.

The examples of FIG. 2 are provided for illustration purposes only as examples of vehicle systems with which embodiments of the disclosed technology may be implemented. One of ordinary skill in the art reading this description will understand how the disclosed embodiments can be implemented with any vehicle platform.

FIG. 3 illustrates an example architecture for personalized adaptive cruise control in accordance with embodiments of the systems and methods described herein. In this example, P-ACC system 300 (e.g., P-ACC system 100 of FIG. 1) includes an P-ACC circuit 310, the plurality of sensors 52, and one or more vehicle systems 320, each of which may be included in vehicle 10 of FIG. 1. Sensors 52 and vehicle systems 320 can communicate with P-ACC circuit 310 via a wired or wireless communication interface. Although sensors 52 and vehicle systems 320 are depicted as communicating with P-ACC circuit 310, they can also communicate with each other as well and with other vehicle systems. P-ACC circuit 310 can be implemented as an ECU or as part of an ECU such as, for example ECU 50. In other embodiments, P-ACC circuit 310 can be implemented independently of an ECU.

ACC circuit 310, in this example, includes a communication circuit 301, a decision circuit 303 (including a processor 306 and memory 308 in this example) and a power supply 312. Components of P-ACC circuit 310 are illustrated as communicating with each other via a data bus, although other communication in interfaces can be included.

Processor 306 can include a GPU, CPU, microprocessor, or any other suitable processing system. Memory 308 may include one or more various forms of memory or data storage (e.g., flash, RAM, etc.) that may be used to store the calibration parameters, images (analysis or historic), point parameters, instructions and variables for processor 306 as well as any other suitable information. Memory 308 can be made up of one or more modules of one or more different types of memory and may be configured to store data and other information as well as operational instructions that may be used by the processor 306 to control P-ACC circuit 310.

Although the example of FIG. 3 is illustrated using processor and memory circuitry, as described below with reference to circuits disclosed herein, decision circuit 303 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up P-ACC circuit 310.

Communication circuit 301 may be either or both a wireless transceiver circuit 302 with an associated antenna 314 and a wired I/O interface 304 with an associated hardwired data port (not illustrated). As this example illustrates, communications with P-ACC circuit 310 can include either or both wired and wireless communications circuits 301. Wireless transceiver circuit 302 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by P-ACC circuit 310 to/from other entities such as sensors 52 and vehicle systems 320.

Wired I/O interface 304 can include a transmitter and a receiver (not shown) for hardwired communications with other devices. For example, wired I/O interface 304 can provide a hardwired interface to other components, including sensors 52 and vehicle systems 320. Wired I/O interface 304 can communicate with other devices using Ethernet or any of a number of other wired communication protocols whether standardized, proprietary, open, point-to-point, networked or otherwise.

Power supply 310 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 52 can include, for example, sensors 52 such as those described above with reference to the example of FIG. 1. Sensors 52 can include additional sensors that may or not otherwise be included on a standard vehicle with which the P-ACC system 100 is implemented. In the illustrated example, sensors 52 include vehicle acceleration sensors 52A to detect accelerator pedal actuation (e.g., acceleration), vehicle speed sensors 52B to detect vehicle speed, wheelspin sensors 52C (e.g., one for each wheel), brake actuation sensor 52D to detect brake pedal actuation such as depressing the brake pedal to reduce the speed (e.g., deceleration), accelerometers such as a 3-axis accelerometer 52E to detect roll, pitch, and yaw of the vehicle (e.g., to detect vehicle heading), proximity sensors 52E (e.g., to detect objects in surrounding proximity to the vehicle), steering angle sensor 52G (e.g., to detect an angle of the wheels 34), environmental sensors 52H (e.g., to detect environmental factors), and vehicle control activation sensor 52I to detect whether the P-ACC system 100 is activated for semi-autonomous/autonomous operation of vehicle 10. Additional sensors 52I can also be included as may be appropriate for a given implementation of P-ACC system 200.

Vehicle systems 320 can include any of a number of different vehicle components or subsystems used to control or monitor various aspects of the vehicle and its performance. In this example, the vehicle systems 320 include a global positioning system (GPS) or other vehicle positioning system 372; torque splitters 374 that can control distribution of power among the vehicle wheels such as, for example, by controlling front/rear and left/right torque split; engine control circuits 376 to control the operation of engine (e.g. Internal combustion engine 14); motor control circuits 378 to control operation of motor/generator (e.g., motor 22); heading control circuits 380 to control the angle of wheels (e.g., wheels 34) to steer the vehicle, and other vehicle systems 382.

In operation, P-ACC circuit 310, by way of communication circuit 301, can receive data from various vehicle sensors 52 regarding vehicle operating conditions, environmental conditions, and/or other conditions relevant to operation of the vehicle, e.g., proximity information regarding road obstacles, neighboring vehicles, etc. Upon receipt of the aforementioned data and/or information, the data/information may be stored in memory 308, e.g., in a cache or buffer portion of memory 308. Decision circuit 303 may access memory 308 to analyze the received data/information to determine what data/information should be retained and/or transmitted to the edge/cloud 105 for use, e.g., by a cloud server to train an AI model.

For example, deactivation of control of vehicle 10 by P-ACC system 100 may be detected by the vehicle control activation sensor 52I. When the ACC system 100 is not activate, decision circuit 303 receives vehicle operating conditions and environmental factors from sensors 52 and stores the received information as historical data set(s) 305 for transmission to the cloud 105. The sensors 52 may be sampled at any desired sampling rate while the P-ACC system 100 is in a deactivated state, for example, sensors 52 collect data every 1/100 of a second and are provided to the P-ACC circuit 310 at the same rate. As another example, the data may be transmitted to the P-ACC circuit 310 at that same or a slower rate, for example, between 5 Hz and 100 Hz, for example, 10 Hz. In some embodiments, historical data set(s) may be transmitted to the cloud as a block of historical data set(s). As used herein, a data set may refer to a single sampling of the sensors 52, and comprises vehicle operating conditions and environmental factors for a single sampled instance, such that the vehicle operating conditions and associated environmental factors correspond in time (e.g., correspond to approximately the same point in time). Data sets as used herein may refer to a plurality of the data sets sampled at a plurality of times. Accordingly, each historical data set comprises historical vehicle operating conditions (e.g., historical demonstration) and historical environmental factors for a given point in time.

In various embodiments, some environmental factors may be pre-stored due to their static or predictable nature and retrieved from memory for inclusion as in each historical data set. For example, vehicle type information may be stored in memory of the vehicle memory, for example, in memory 308 or in another memory of vehicle 10 (e.g., another memory coupled to the ECU 50). The vehicle type information may be indicated by, for example, a Vehicle Identification Number (VIN). The decision circuit 310 may retrieve a VIN number of vehicle 10 and include the VIN with historical data set(s) 305. Alternatively, for the purpose of privacy and security, the decision circuit 310 may detect a vehicle type from the VIN and include only the determined vehicle type with each historical data set. In another example, vehicle type information may be stored on the cloud-based database. When data sets (e.g., data set(s) 305 and/or 307) are sent to the cloud (e.g., via communication circuit 301), for example, with a VIN and driver identifier, the vehicle type information can be matched up with VIN by searching cloud-based database.

As alluded to above, one or more vehicle systems 320 may also provide information relevant to vehicle operation to P-ACC circuit 310. For example, weather information, time of day information, road type, road surface condition, and degree of traffic may also be acquired from other vehicle systems 382, either in place of or in combination with detection from environmental sensors 52I. For example, weather information from other vehicle systems 382 (e.g., on-board weather system), used for displaying such information on a heads-up display, may be received by the decision circuit 310 and included with the historical data set. Time of day information, road type, surface condition, and traffic may also be similarly retrieved from on-board vehicle systems. As part of these other vehicle systems 382, the information may be received by the decision circuit via a V2X communication from external networks.

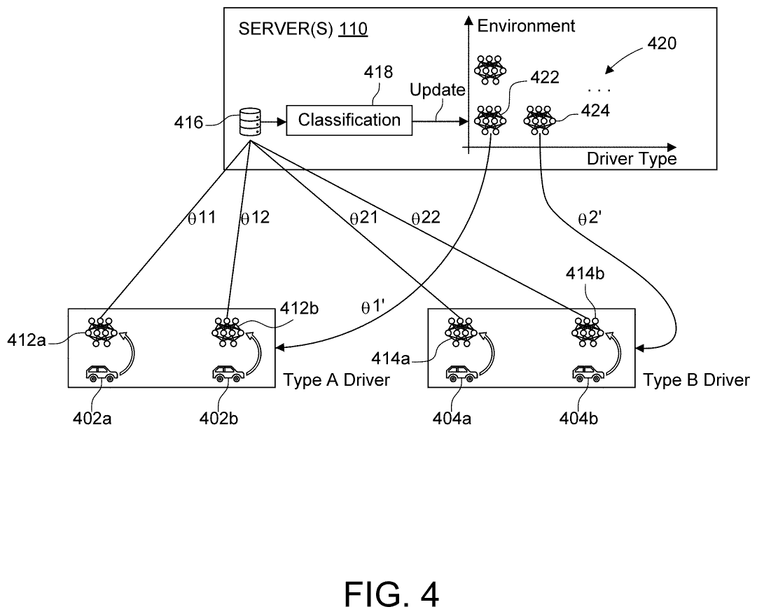

The decision circuit 310 then transmits (e.g., via a communication circuit 301) the historical data set(s) 305 to the edge/cloud. As described above, cloud servers hosted by the cloud 105 apply AI algorithms on the historical data set(s) to first define a plurality of driver type classifications and then classify each historical data set as a driver type classification according to vehicle operating conditions and environmental factors. The edge/cloud then applies ML techniques to learn control policy models for each driver type classification. For example, various embodiments disclosed herein apply IRL to infer control policy models for each driver type classification and environmental factor group. Further details are provided below in connection with FIGS. 4-7.

Upon activation of control of vehicle 10 by P-ACC system 100 being detected by the vehicle control activation sensor 52I, decision circuit 303 receives vehicle operating conditions and environmental factors from sensors 52 for a preset time period prior to activation and stores the received information as current data set(s) 307, for transmission to the cloud 105. The vehicle operating conditions and environmental factors maybe be received from sensors 52 as set forth above with respect to the historical data set(s) 305, except that the current information is stored as current data set(s) 307 based on the detecting activation of control of the vehicle. As alluded to above, each current data set comprises current vehicle operating conditions (e.g., a current demonstration) and historical environmental factors for a given point in time. The data set(s) 305 and 307 may be stored in memory 308 or in another memory of the P-ACC system 300.

In some embodiments, the time period for collection of the current information precedes activation of the P-ACC for vehicle control, which may result in sensed data collected during this time being stored as historical data set(s). Accordingly, the decision circuit 303 locates the data set(s) corresponding to the time period prior to vehicle control activation and repurposes the located data as current data set(s).

The current data set(s) 307 may be used to identify a driver type classification corresponding to the current demonstrations and environmental factors. For example, according to some embodiments, the decision circuit 10 may perform real-time driver classification and environmental factor rasterization on the current data set(s) 307 to classify the driver type. The P-ACC circuit 310 then transmits a V2X communication comprising the identified driver type and environmental factors to the cloud 105. As another example, the P-ACC circuit 310 may transmit a V2X communication to the cloud/edge including the current data set(s) 307. The cloud/edge may perform real-time driver classification and environmental factor rasterization on the current data set(s) 307 to classify the driver type.

Subsequently, the P-ACC circuit 310 receives information relevant to operation of the vehicle via V2X communications, e.g., a control policy model, from the cloud 105. For example, the cloud 105 retrieves the control policy model corresponding the driver type classification and communicates the model to the P-ACC circuit 310. From the control policy model, the decision circuit 303 calculates a control policy including vehicle operation inputs for controlling vehicle system 320. The control policy may define inputs that substantially mimics a vehicle operating behavior of a similarly classified driver type in environment conditions based on a rasterization of the environmental factors. For example, the control policy may comprise acceleration/deceleration inputs that mimic the vehicle following behavior of the driver type classification identified based on the current data set(s) 307. In another example, the control policy may comprise input that mimic the vehicle-following and lane-keeping behaviors of the driver type classification.

In various embodiments, communication circuit 301 can be used to send an control signals to various vehicle systems 320 as part of controlling the operation of the vehicle, for example, according to the control policy. For example, communication circuit 301 can be used to send vehicle operation inputs as signals to, for example, one or more of: motor controllers 376 to, for example, control motor torque, motor speed of the various motors in the system to control acceleration and/or declaration of the vehicle according to the control policy; ICE control circuit 376 to, for example, control power to engine 14 to, for example, to control acceleration and/or declaration of the vehicle according to the control policy; and/or brake pedal actuation, for example, to decelerate the vehicle according to the control policy. Thus, in various embodiments, control of the vehicle systems 320 according to the control policy maintains a vehicle-following distance between vehicle 10 and a lead vehicle in accordance with the calculated control policy. In some embodiments, the communication circuit 301 can be also used to send signals to, for example, the heading control circuit 380 to control a steering angle of the wheels 34 to control vehicle heading, for example, in a case where the control policy controls the vehicle in autonomous operation mode.

The decision regarding what action to take via these various vehicle systems 320 can be made based on the information detected by sensors 52. For example, proximity sensor 52F may detect a lead vehicle at a distance from the vehicle 10. Decision circuit 303 may determine, from the control policy that is based on a driver type classification identified from the current data set(s) 307, that that the following distance should be increased so to maintain the vehicle-following behavior of the driver type classification. The communication circuit 301 may communicate control signals from the decision circuit 308 to control declaration of the vehicle (e.g., reduce power output from engine 14, reduce motor speed of motor 22, and/or brake pedal actuation) to achieve a following distance according to the control policy. Similarly, the following distance may be reduced according to the control policy.

FIG. 4 is another example of the architecture of a P-ACC system 400 used is performed according to various embodiments disclosed herein. The P-ACC system 400 comprises one or more edge/cloud severs 410 (e.g., cloud servers resident on a network) communicably coupled to a plurality of vehicles, illustratively depicted in FIG. 4 as vehicles 402a, 402b, 404a, and 404b. Each vehicle 402a, 402b, 404a, and 404b may be substantially similar to vehicle 10 of FIG. 1 and include a P-ACC system 300, such as a P-ACC circuit, on-board sensors, and vehicle systems that are substantially similar to the P-ACC circuit 310, sensors 52, and vehicle systems 320 of FIG. 3.

Vehicles 402a, 402b, 404a, and 404b (collectively referred to herein as Vehicles 402 and 404) each represents a physically different vehicle operated by a physically different driver. As described above, each vehicle shown in FIG. 4 includes on-board sensors (e.g., sensors 52) used to detect various conditions internal or external to each vehicle, for example, various vehicle operating conditions and environmental factors. For example, sensors on vehicle 402a detect vehicle operating conditions and environmental factors which are packaged one or more demonstrations 412a. Similarly, vehicle 402b, 404a, and 404b detect vehicle operating conditions and environmental factors and packages them into one or more demonstrations 412a, 414a, and 414b, respectively. Each demonstration may include a data set, such as those described above in connection with FIG. 3.

Each vehicle may communicate a V2X communication (e.g., communication circuit 301) to the cloud server(s) 110 including the respective demonstration. For example, vehicle 402a transmits communication θ₁₁ to cloud server(s) 110, which is stored in one or more cloud-based databases 416. Similarly, vehicles 402b, 404a, and 404b each transmit communication θ₁₂, communication θ₂₁, communication θ₂₂, respectively, to cloud server(s) 110. Demonstrations 412a-414b are communicated to the cloud server(s) 110 via communication θ₁₂ through θ₂₂.

In operation, in the case of a learning phase, demonstrations 412a-414b represent historical demonstrations (e.g., historical data set(s) 305) from each vehicle 402a, 402b, 404a, and 404b, transmitted to cloud server(s) 110. The cloud server(s) 110 apply AI algorithms on the historical demonstrations to define a plurality of driver type classifications and to classify each demonstration into one of the driver type classification. For example, the cloud server(s) 110 may execute a classification engine 418 executing unsupervised learning algorithms one demonstrations 412a-414b to identify clusters of demonstrations, the boarders may define driver type classifications. Each demonstration 412a-414b is then classified into one of the identified driver type classifications based on a similarity between the vehicle operating conditions and environmental factors of each respective demonstration and the cluster that define the driver type classification.

The cloud server(s) 110 then learns a plurality of control policy models from the plurality of driver type classification and included demonstrations using IRL algorithms. For example, for each driver type classification, the demonstrations within the driver type are input into an IRL algorithm to learn a control policy model for a respective driver type classification. As a result, each model is a reward function from which a reward may be inferred (e.g., a control policy) based on given observed behavior (e.g., demonstrations). FIG. 4 graphically illustrates the plurality of control policy models as plot 420 where each control policy model plotted according to driver type and environment conditions, for illustrative purposes only.

For example, the cloud server(s) 110 classify demonstrations 412a and 412b from vehicles 402a and 402b, respectively, as Type A Driver according to historical vehicle operating conditions and environmental factors included in each demonstration. Similarly, demonstrations 414a and 414b are classified as a Type B driver according to historical vehicle operating conditions and environmental factors of each demonstration. The cloud server(s) 110 then apply an IRL algorithm on the received demonstrations for each driver type classification to train a control policy model for the respective driver type classification. For example, demonstrations 412a and 412b are input into the IRL algorithm to train a control policy model 422 for Type A Driver classification and demonstrations 414a and 414b are input into the IRL algorithm to train a control policy model 424 for Type B Driver classification.

While three control policy models are shown in plot 420, as alluded to by the ellipsis, there may be any number of driver type categories derived from the unsupervised learning. Furthermore, while four vehicles are shown, demonstrations from any number of vehicles may be received. Four vehicles are shown for illustrative purposes.

Accordingly, systems and method disclosed herein are capable of learning a model to infer vehicle operation behaviors for a plurality of driver types in different environmental conditions through the application of AI/ML techniques applied to historical data from similarly situated drivers with similar driving styles.

In the vehicle control phase, as alluded to in connection with FIG. 1, each respective vehicle collects one or more current demonstration (e.g., current vehicle operating conditions and environmental factors, such as current data set(s) 307), which are used to classify the current driving behavior of the vehicle according to a driver type classification. The algorithm applied to the current demonstration may be similar to the algorithm applied to the historical demonstration for classification purposes. As noted above, the driver type classification may be performed in real-time at the vehicle or in the cloud server(s) 110.

Based on the driver type classification of the current demonstration, a corresponding trained control policy model is identified and downloaded from the cloud server(s) 110. For example, in a case of the vehicle control phase, demonstration 412a for vehicle 402a can be a current demonstration used to classify the vehicle as a Type A Driver. The cloud server(s) 110 identify the control policy model 422 corresponding to a Type A Driver and transmit the control policy model 422 as a V2X communication to vehicle 402a. The P-ACC circuit (e.g., P-ACC circuit 310) of vehicle 402a calculates a control policy (e.g., vehicle operation inputs) from the control policy model, which can be supplied the vehicle systems to controls the vehicle 402a according to the control policy model. Similarly, as shown by the box grouping vehicle 402b with 402a, vehicle 402b is classified as a Type A Driver based on current demonstration 412b and vehicle 402b receives the control policy model 422 (e.g., same control policy model as vehicle 402b) for controlling vehicle 402b. Whereas, vehicles 404a and 404b are classified as Type B Drivers according to their respective demonstrations 414a and 414b, such that vehicles 404a and 404b receive control policy model 424.

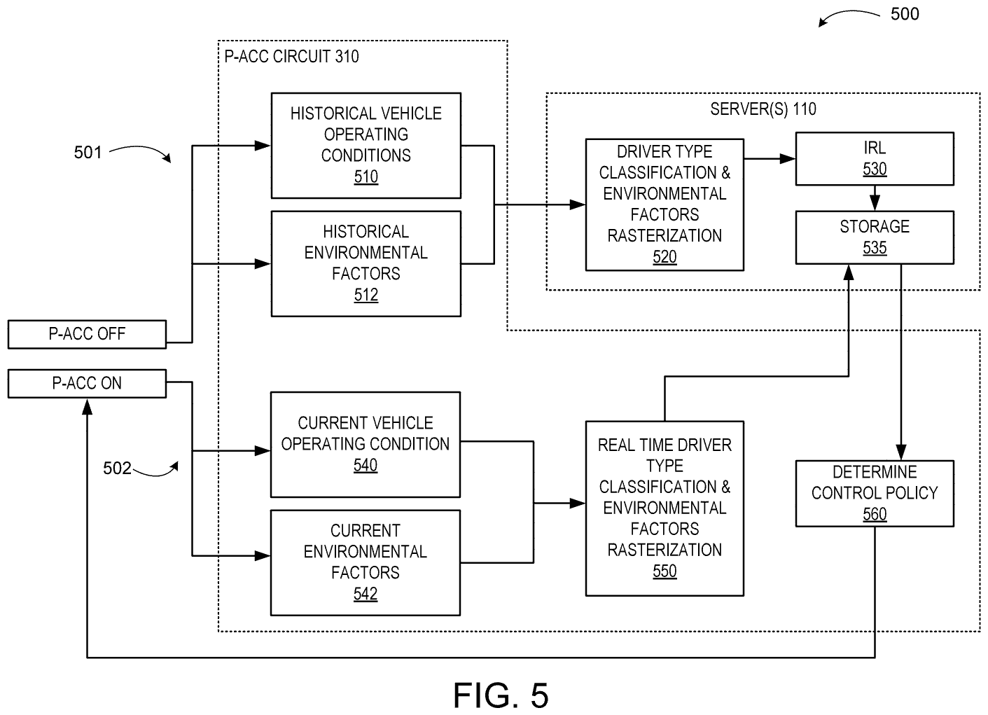

FIG. 5 schematically illustrates an example flow diagram illustrating example operations for an implementation of P-ACC in accordance with embodiments disclosed herein. In this example, the process 500 disclosed herein may be performed by various devices described herein, for example, the cloud servers 505, which may be implemented as cloud server(s) 110 and/or 410 and cloud-based database 416 illustrated in FIGS. 1, 3, and 4 and the P-ACC circuit 310 illustrated in FIG. 3.

FIG. 5 illustrates process 500 that includes a training process 501 and a vehicle control process 502 in a closed loop flow. As alluded to above, a P-ACC system may be in an OFF state (e.g., “P-ACC OFF”) where vehicle control by the P-ACC system is deactivated or an ON state (e.g., “P-ACC ON”) where vehicle control by the P-ACC system is activated. While the P-ACC system is deactivated, the process 500 executes a training process 501, whereby a control policy model is trained based on historical demonstrations (e.g., historical data set(s) 305). Whereas, while the P-ACC system is activated, the process 500 executes a vehicle control process 502, whereby a control policy model is identified based on current demonstrations (e.g., current data set(s) 307), which are used to identify a control policy model (e.g., personalized based on an driver type classification) from which a control policy is calculated for controlling the vehicle 10.

In the training process 501, at blocks 510 and 520, the P-ACC circuit 310 receives historical vehicle operating condition and historical environmental factors, packages the information together as historical demonstrations (e.g., historical data set(s) 305) and sends the historical demonstrations to a cloud server(s) 505. For example, the P-ACC circuit receives vehicle operating conditions and environmental factors from one or more sensors 52 and/or vehicle systems 320 as described above in connection with FIG. 3. While not shown in FIG. 5 a plurality of vehicles (each comprising a P-ACC circuit such as P-ACC circuit 310) may performs blocks 510 and 512, such that the cloud server(s) 505 receive historical demonstrations from a plurality of vehicles.

In various embodiments, a vehicle-following behavior (also known as a vehicle following dynamic) may be considered according to second-order dynamics as follows:

$$\begin{matrix}x = ( \begin{matrix}p \\ v \\ d\end{matrix} ) & Eq . 1 \\ \dot{x} = ( \begin{matrix}\dot{p} \\ \dot{v} \\ \dot{d}\end{matrix} ) = ( \begin{matrix}v \\ a \\ {v}_{f} - v\end{matrix} ) = A ( \begin{matrix}p \\ v \\ g\end{matrix} ) + B \cdot a + C \cdot {v}_{f} & Eq . 2\end{matrix}$$

where x represents the system state, p is a position of an ego vehicle, v is a speed of the ego vehicle, v_{f} is an estimated speed of a leading vehicle, and d is the following distance between the ego vehicle and a leading vehicle. Where the overdots in Eq. 2 indicate derivatives are taken for each measurement with respect to time. A is a state matrix, B is an input matrix, and C is a disturbance matrix.

Accordingly, a set of sampled historical vehicle operating conditions may include, for example, a position of the vehicle 10 (e.g., from other vehicle positioning system 372), a speed of the vehicle 10 (e.g., from the vehicle speed sensors 52B), a space gap between the vehicle 10 and a lead vehicle (e.g., from proximity sensor 52F), and an estimated speed of the lead vehicle (e.g., calculated based on a change of the space gap from proximity sensor 52F and the vehicle speed from vehicle speed sensor 52B). The historical vehicle operation conditions may be applied to Eq. 1 and Eq. 2 above to determine historical vehicle following dynamics of the driver.

At block 520, the cloud sever(s) 505 perform driver type classification using the historical environmental factors and vehicle operating conditions from blocks 510 and 512. For example, the cloud server(s) 505 may receive hundreds, thousands, etc. historical demonstrations from numerous vehicles. Cloud server(s) 505 perform driver type classification by clustering the received historical demonstrations based on similarity of the environmental factors and vehicle operating conditions to define driver types.

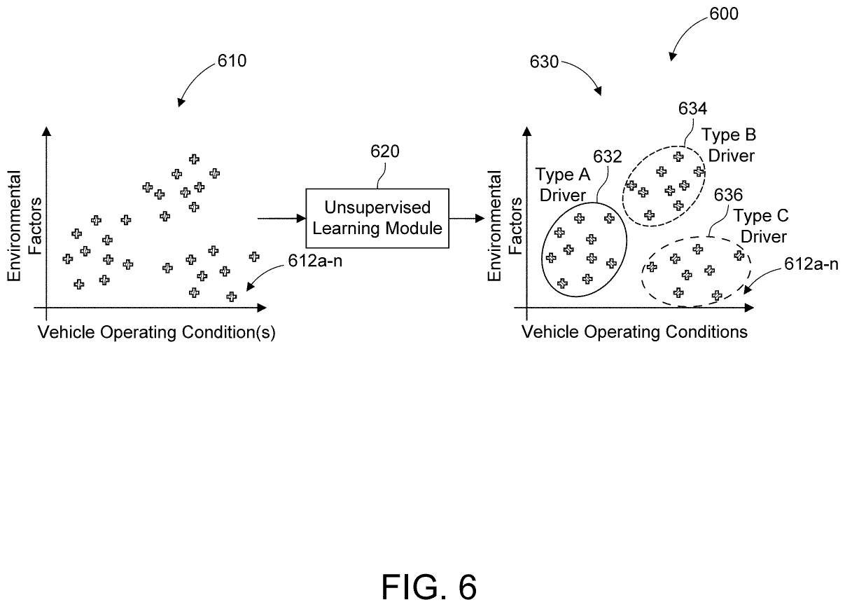

For example, FIG. 6 schematically illustrates an example flow 600 for driver type classification using historical vehicle operating conditions and environmental factors according to embodiments disclosed herein. FIG. 6 illustrates an application of an unsupervised learning algorithm, where historical demonstrations are inputs, that clusters the historical demonstrations and forecasts driver type classification boundaries. Demonstrations within a classification boundary may be representative of a driver type classification having vehicle operating conditions and environmental factors of those demonstrations contained within the boundary.

FIG. 6 illustrates plot 610 historical demonstrations 612a-n plotted according to vehicle operating conditions and environmental factor. Each data point 612a-n is representative of a single historical demonstration received according to blocks 510 and 512, such as a set of historical environmental factors and corresponding vehicle operating conditions of a respective vehicle at a single point in time. Data point 612a-n may be received from one or more vehicles throughout the training process 501.

The historical data set(s) represented by data points 612a-n are then supplied to a unsupervised learning module 620 (e.g., at block 520) executed at the cloud server(s) 505. The unsupervised learning module identifies clusters of data points 612a-n and forecasts classification boundaries between the clusters through unsupervised learning algorithms as known in the art. Each bounded cluster represents a driver type classification, where the driver type corresponds to the vehicle operating conditions within the environmental factors defined by the demonstrations within the boundary. For example, as shown in plot 630, classification boundaries 632, 634, and 636 are forecasted and classified as Type A Driver, Type B Driver, and Type C Driver, respectively, each comprising a subset of the data points 612a-n (e.g., subset of demonstrations). Each subset of demonstrations includes, in the aggregate, a set of vehicle operating conditions and environmental factors. As such, a plurality of driver type classifications are identified by the server(s) 505 and a set of vehicle operating conditions are associated therewith.

Also at block 520, the cloud server(s) 505 bins the environmental factors into categories of environmental conditions, for example, by executing a rasterization on the each set of environmental factors. A set of environmental factors may be stored in vector format, and the cloud server(s) 505 rasterizes the vector for each set of environmental factors to generate a corresponding raster image. Through an application of unsupervised learning (e.g., by the unsupervised learning module 620) to the environmental factor rasterizations, the cloud server(s) 505 bins the raster images into categories of environments. Each environment category corresponds to a grouping of environmental factors. For example, a first category may be a rainy night and a sedan driven on a freeway and a second category may be a sunny day and a SUV driven on a rural street. It will be appreciated that there may be numerous permutations and classifications that may be identified. The server(s) 505 then associate each driver type classifications with a environmental category (or bin)

Returning to FIG. 5, at block 530, the cloud server(s) 505 trains an control policy model for the plurality of driver type classifications and associated environmental category. For example, the cloud server(s) 505, for each driver type classification and associated environmental category, historical demonstrations classified thereto are input into an IRL algorithm to learn a control policy model for each driver type classification and environmental category.

For vehicle operating dynamics of a given driver type classification, determining an explicit reward for a given action (or state) may be difficult. Additionally, distinguishing between which action (or state) that leads to a positive or negative reward may be difficult without first knowing the explicit rewards. Embodiments disclosed herein overcomes these difficulties by applying an IRL algorithm to historical demonstrations to infer a reward functions (R) for each driver type classification and environmental category.

The IRL algorithms disclosed herein address the problem of inferring vehicle operating dynamics (e.g., a reward function (R)) of each driver type, given observed behavior of each driver type. The observed behavior is supplied in the form of the historical demonstrations, which are first classified into respective driver types. The historical demonstrations for a target driver type classification are reversely introduced as the reward function (R). A reward function R is expressed as a linear combination between a predefined reward basis vector Φ and it's corresponding weight α. Given the coefficient α, the cumulative reward ρ of a demonstration is shown in the following equation:

$$p ( π \vert {α}^{T} ) = 𝔼 [ {\sum }_{t = 0}^{+ ∞} {γ}^{t} R ( {s}_{t} ) \vert π ] = 𝔼 [ {\sum }_{t = 0}^{+ ∞} {γ}^{t} {α}^{T} Φ ( {s}_{t} ) \vert π ] \qquad Eq . 3$$

t is a time instant of the demonstration, T is the transpose of a vector, and γ is a discount factor.

In various embodiments, a state (s) may be defined based on a speed of an ego vehicle (e.g., vehicle 10 in FIG. 5) and a following distance between the ego vehicle and a lead vehicle, for example, according to Eq. 1 and Eq. 2 above. A gaussian radial kernel function may be defined as the reward basis to improve the nonlinear representation ability. For each state s, its relationship with any s state, si, in the state space is mapped using the kernel function as follows:

$$\begin{matrix}Φ ( s ) = [ \begin{matrix}{Φ}_{1} ( s ) \\ {Φ}_{2} ( s ) \\ … \\ {Φ}_{n} ( s )\end{matrix} ] = [ \begin{matrix}K ( s , {s}_{1} ) \\ K ( s , {s}_{2} ) \\ … \\ K ( s , {s}_{n} )\end{matrix} ] & Eq . 4 \\ K ( S , {S}_{i} ) = exp ( - \frac{{‖ s - {s}_{i} ‖}_{2}^{2}}{{σ}^{2}} ) & Eq . 5\end{matrix}$$

The value of a is selected manually based on the resolution of the state space to obtain a balance between underfitting and overfitting.

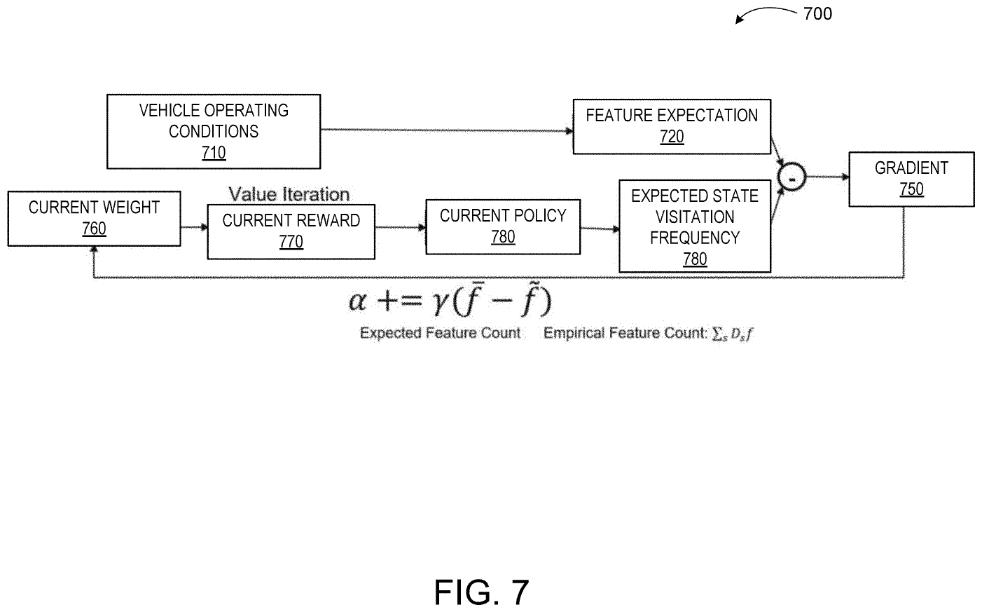

A maximum entropy (Max-Ent) of a control policy model for each driver type classification can be calculated from corresponding historical demonstrations. For example, FIG. 7 schematically illustrates an example flow diagram illustrating example operations for recovering a reward function of a demonstration based on Max-Ent of an IRL in accordance with embodiments disclosed herein. In this example, the process 700 disclosed herein may be performed by various devices described herein, for example, the cloud server(s) 110, 410, and 505 and cloud-based database 416 illustrated in FIGS. 1, 3, 4, and 5. Process 700 illustrates the calculations performed for one driver type classification, and may be duplicated for each driver type classification.

In a first iteration, at blocks 710 and 720, historical vehicle operating conditions and historical environmental factors corresponding to the driver type classification are fed into a subtraction function. For example, each demonstration classified as the target driver type are fed into the subtraction function. At block 760, a current weight α is applied to a current reward function (e.g., as calculated as described above in connection with Eq. 3-5), which is iterated through all reward values at block 770. In the first iteration, the current weight a may be set randomly. The current reward values define a current control policy at block 780, which represents states based on the reward values. The calculated states are then analyzed to calculate an expected state visitation frequency at block 780 and feed into the subtraction function. At block 750, a gradient of the Max-Ent of the IRL is output.

For example, the process 700 illustrates the IRL algorithm that calculates the gradient of the weight based on the maximum entropy criteria, which can be derived as follows:

$$p ( ξ \vert α ) = \frac{1}{Z ( α )} exp ( {\sum }_{t} {R}_{α} ( {s}_{t} ) ) = \frac{1}{Z ( α )} exp ( {\sum }_{t} {α}^{T} Φ ( {s}_{t} ) ) \qquad Eq . 6$$

where Z(α), called partition function, equals to Σ_{ξ} exp (Σₜ R_{α}(sₜ)). To recover the reward function, the maximum log likelihood method is used at the demonstrations with respect to the weight of the reward function.

$$L ( α \vert ξ ) = {max}_{α} {\sum }_{ξ} log p ( ξ \vert α ) \qquad Eq . 7$$

Then, the gradient of the weight α can be written in the following form:

$${∇}_{α} L = {\sum }_{ξ} p ( ξ ) {\sum }_{s ∈ ξ} Φ ( s ) - {\sum }_{ξ} {D}_{s} {\sum }_{s ∈ ξ} ( s ) = \tilde{f} - \overline{f} \qquad Eq . 8$$

Where ξ represent a series of data (trajectory), p is a probability of a trajectory, \tilde{f} is an expected feature count, f̅ is an empirical feature count, and Dₛ is a state visitation frequency.

Once the gradient of the Max-Ent of the IRL is derived for the first iteration, the derived gradient is used to update the weight α as shown in FIG. 7. For example, α+=γ(f̅−\tilde{f}) indicates that new a for the next iteration is the current α plus γ(f̅−\tilde{f}), where γ in this equation is a learning rate (also referred to as update rate) and Dₛ is a state visitation frequency under current policy. The updated weight is fed back to block 760 and applied for a second iteration of process 700, which updates the derived gradient of the Max-Ent of the IRL. As the reward R is the linear combination of weight α and state s, recovering α is equivalent to removing reward R. The number of iterations of process 700 may be based on computation time and definitions of the state space, for example, 30-50 iterations according to some embodiments.

The calculated reward functions (R) are stored at block 536 in a cloud-based database (e.g., database 416) as control policy models. Each reward function is associated with its corresponding driver type classification. Each control policy model may be accordingly based on application of a Max-Ent IRL that infers a reward function about how a driver type classification will behave, for example, during a vehicle-following maneuver, based on historical demonstrations from a plurality of other vehicles. The recovered reward function not only can help explain the observed demonstrations (e.g., historical data from on-board sensors) but also represent preferences of the driver if the driver were to execute the same task, opposed to directly mimicking the behavior of the observed demonstrations. As a result, each reward function is a representation of the unique driving dynamics for a target driver type classification, which the P-ACC system may utilize controlling the vehicle.

In the vehicle control process 502, at blocks 540 and 542, the P-ACC circuit 310 receives current vehicle operating condition and current environmental factors (e.g., within a time period prior to the P-ACC being activated for vehicle control) and packages the information together as current demonstrations (e.g., current data set(s) 307).

An example set of sampled current vehicle operating conditions may include, for example, a position of the vehicle 10 (e.g., from other vehicle positioning system 372), a speed of the vehicle 10 (e.g., from the vehicle speed sensors 52B), a space gap between the vehicle 10 and a lead vehicle (e.g., from proximity sensor 52F), and an estimated speed of the lead vehicle (e.g., calculated based on a change of the space gap from proximity sensor 52F and the vehicle speed from vehicle speed sensor 52B). The current vehicle operation conditions may be applied to Eq. 1 and Eq. 2 above to determine current vehicle following dynamics of the driver.

At block 550, real-time driver type classification is performed using the current environmental factors and vehicle operating conditions from blocks 540 and 542 (e.g., current demonstration). For example, as illustrated in FIG. 5, the P-ACC circuit 310 may perform real-time driver type classification and environmental factors rasterization on the current demonstrations to identify a driver type classification for the current demonstrations. The algorithm for block 550 may be similar to that of block 520, except that inputs are current demonstrations from a single vehicle. For example, current demonstrations may be input unsupervised learning with the historical demonstrations to classify the current demonstration. Through the algorithms as set forth above, a driver type classification can be identified for the current demonstrations in real-time and supplied to the cloud sever(s) 505 as P-ACC server request in a V2X communication, with the current demonstrations. In another example, block 550 may be executed at the cloud sever(s) 505, for example the current demonstrations from blocks 540 and 542 may be communicated to the cloud server(s) 505, where the cloud sever(s) classify the current demonstration to identify a driver type classification.

At block 535, the cloud server(s) 505 retrieves a control policy model, stored in the cloud-based database, associated with the driver type classification from block 550. The cloud server(s) 505 transmit the retrieved control policy model to the P-ACC circuit 310.

At block 560, a control policy is determined from the received control policy model. For example, the decision circuit 303 of the P-ACC circuit 310 is configured to calculate a control policy from the control policy model using, for example, the current demonstrations as inputs into the model. The MPC calculates an optimal control policy (e.g., acceleration) based on the recovered (e.g., inferred) reward function that is the control policy model.

For example, the decision circuit 303 of the P-ACC circuit 310 may include a Model Predictive Controller (MPC) configured to calculate a sequence of optimal control policies within a set time window considering current demonstrations (e.g., from blocks 540 and 542). This time window, according to some embodiments, may be set between 1 second and 10 seconds, and, in some embodiments, between 2 seconds and 5 seconds. In the case of vehicle-following applications, the recovered reward function from the IRL represents a target following distance that a driver type classification prefers to maintain based on the current speed and current environmental factors. The MPC calculates the control sequence based on an quadratic objective as follow:

$$\begin{matrix}min J = \frac{1}{2} {\sum }_{k = 0}^{N - 1} \{ {( {x}_{k} - {r}_{k} )}^{T} Q ( {x}_{k} - {r}_{k} ) + {a}_{k}^{T} {Ra}_{k} \} + \frac{1}{2} {( {x}_{N} - {r}_{N} )}^{T} Q ( {x}_{N} - {r}_{N} ) & Eq . 9 \\ s . t . x = ( \begin{matrix}p \\ v \\ g\end{matrix} ) \\ \dot{x} = Ax + B \cdot a + C \cdot {v}_{f} & Eq . 10 \\ {Acc}_{min} \leq {a}_{k} \leq {Acc}_{max} & Eq . 11\end{matrix}$$

where xₖ is the current state of the vehicle (e.g., calculated from current demonstrations using, for example, Eq. 1 and Eq. 2 above), rₖ is a desired state to be followed, x_{N} is the final quadratic state of the vehicle at time horizon, r_{N} is a final quadratic state to be followed, A is the state matrix, a is a control input (e.g., acceleration in this example), J is an objective function to be optimized, Accₘᵢₙ and Accₘₐₓ are the minimum and maximum feasible control inputs (e.g., max and min acceleration in this example) for the controlled vehicle, and Q and R define the weighting matrices of the objective function to be tuned, respectively. In the case of vehicle-following, rₖ may represent the desired following distance. Because the speed of the front vehicle is known to the MPC (e.g., from on-board sensors), it can be assumed to be a constant speed within the time window.

Either at the end of the time window or prior thereto, the MPC may recalculate the control policy for a subsequent time window to continue to control the vehicle according to the control policy model. The recalculation may be repeated for sequential time windows until vehicle control by the P-ACC system is deactivated.

Accordingly, embodiments disclosed above apply a modeled-based IRL to model to personalize vehicle-operating controls according to an inferred behavior personalized to a driver type, where the IRL provides a reward function as the output. The P-ACC circuit, for example, a MPC controller, is implemented to calculate a control policy sequence within a time window. Because the model-based IRL algorithm utilizes prior knowledge about vehicle-operating dynamics and environmental conditions, embodiments herein provide an improvement over existing P-ACC designs. Also, utilizing the cloud-based framework, historical driving data can be uploaded to the cloud sever(s) and used to pre-train the control policy models, which can be downloaded to vehicles. In this way, embodiments disclosed herein are configured to perform real-time personalized adaptive cruise control. Furthermore, environmental factors and driver type is considered to classify different vehicle-following scenarios, which can significantly improve the performance of the system and reduce driver override of vehicle control systems.

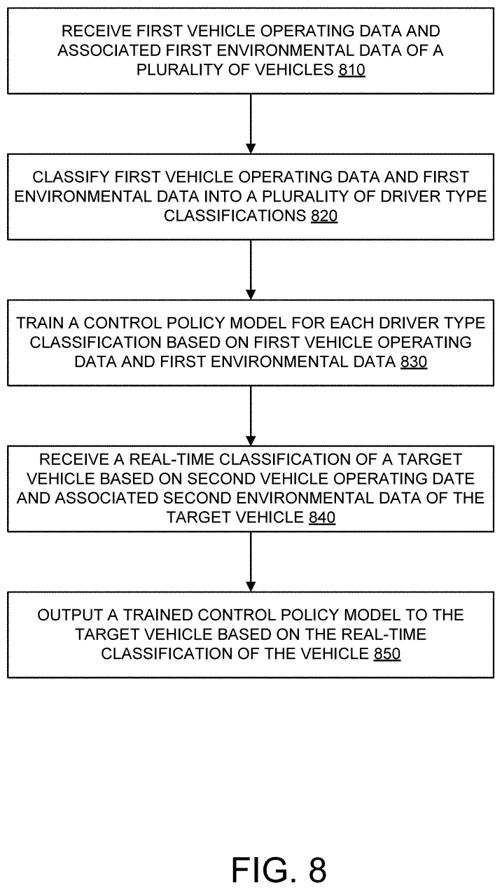

FIG. 8 is an example flow chart illustrating example operations for implementing personalized adaptive cruise control in accordance with various embodiments disclosed herein. In this example, the process may be performed by various devices described herein, including the network edge devices or cloud servers 505 or P-ACC circuit 100 in FIGS. 1 and 3-5.

At block 810, the process may receive first vehicle operating data and associated first environmental data of a plurality of vehicles. For example, first vehicle operating data may be historical vehicle operating conditions and first environmental data may be historical environmental factors collected by a plurality of vehicles and transmitted to network edge device or cloud server, as described above. As alluded to above, the first vehicle operating data is associated with the first environmental data based on a correspondence in time (e.g., collected at by vehicle sensors at approximately the same time).

At block 820, the process may classify the first vehicle operating data and the first environmental data into a plurality of driver type classifications. For example, as described above, the first vehicle operating data and the first environmental data into a plurality of driver type classifications based on unsupervised learning techniques.

At block 830, the process may train a control policy model for each driver type classification based on the first vehicle operating data and the first environmental data. For example, as described above, the first vehicle operating data and first environmental data are input into an IRL to teach a control policy model for each driver type classification.

At block 840, the process may receive a real-time classification of a target vehicle based on second vehicle operating data and associated second environmental data of a target vehicle. For example, second vehicle operating data may be current vehicle operating conditions and second environmental data may be current environmental factors collected by a target ego vehicle. In some embodiments, the target ego vehicle may perform the classification locally, while in other embodiments the classification may be performed on the network edge device or cloud server.

At block 850, the process may output a trained control policy model to the target vehicle based on the real-time classification of the vehicle. For example, using the real-time classification, the network edge device or cloud server may retrieve a control policy model corresponding to the driver type classification from block 840. The target vehicle can then use the control policy model to calculate a control policy to infer inputs for controlling vehicle driving (e.g., through inputs in vehicle systems 320).

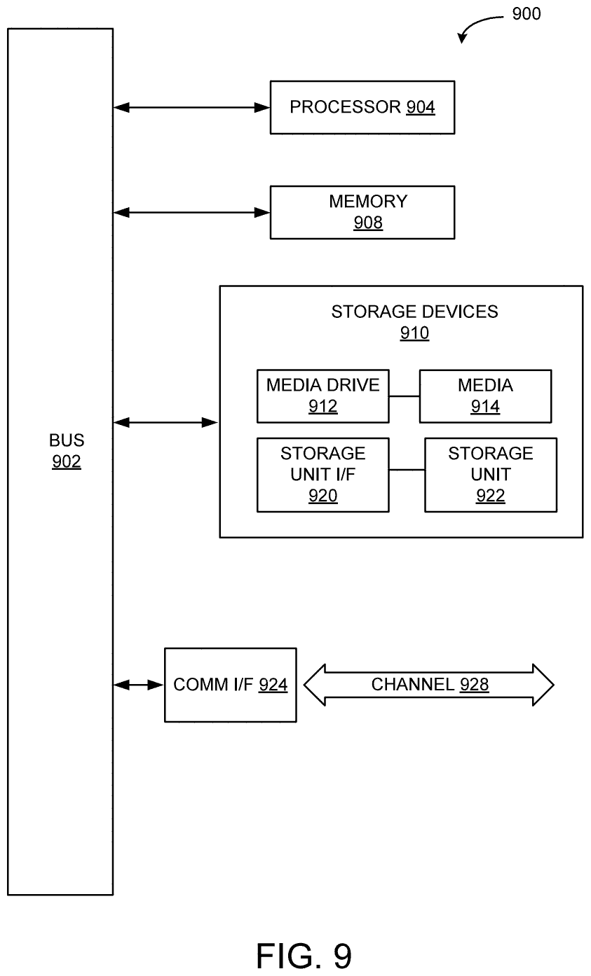

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 9. Various embodiments are described in terms of this example-computing component 900. After reading this description, it will become apparent to a person skilled in the relevant art how to implement the application using other computing components or architectures.

Referring now to FIG. 9, computing component 900 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 900 might also represent computing capabilities embedded within or otherwise available to a given device. For example, a computing component might be found in other electronic devices such as, for example, portable computing devices, and other electronic devices that might include some form of processing capability.

Computing component 900 might include, for example, one or more processors, controllers, control components, or other processing devices. This can include a processor, and/or any one or more of the components making up P-ACC system disclosed herein, such as, for example, the cloud sever(s) 110, 410, 510, P-ACC circuit 310, etc. Processor 904 might be implemented using a general-purpose or special-purpose processing engine such as, for example, a microprocessor, controller, or other control logic. Processor 904 may be connected to a bus 902. However, any communication medium can be used to facilitate interaction with other components of computing component 900 or to communicate externally.

Computing component 900 might also include one or more memory components, simply referred to herein as main memory 908. For example, random access memory (RAM) or other dynamic memory, might be used for storing information and instructions to be executed by processor 904. Main memory 908 might also be used for storing temporary variables or other intermediate information during execution of instructions to be executed by processor 904. Computing component 900 might likewise include a read only memory (“ROM”) or other static storage device coupled to bus 902 for storing static information and instructions for processor 904.

The computing component 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a solid-state drive, a magnetic tape drive, an optical drive, a compact disc (CD) or digital video disc (DVD) drive (R or RW), or other removable or fixed media drive might be provided. Storage media 914 might include, for example, a hard disk, an integrated circuit assembly, magnetic tape, cartridge, optical disk, a CD or DVD. Storage media 914 may be any other fixed or removable medium that is read by, written to or accessed by media drive 912. As these examples illustrate, the storage media 914 can include a computer usable storage medium having stored therein computer software or data.

In alternative embodiments, information storage mechanism 910 might include other similar instrumentalities for allowing computer programs or other instructions or data to be loaded into computing component 900. Such instrumentalities might include, for example, a fixed or removable storage unit 922 and an interface 920. Examples of such storage units 922 and interfaces 920 can include a program cartridge and cartridge interface, a removable memory (for example, a flash memory or other removable memory component) and memory slot. Other examples may include a PCMCIA slot and card, and other fixed or removable storage units 922 and interfaces 920 that allow software and data to be transferred from storage unit 922 to computing component 900.

Computing component 900 might also include a communications interface 924. Communications interface 924 might be used to allow software and data to be transferred between computing component 900 and external devices. Examples of communications interface 924 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 924 may be carried on signals, which can be electronic, electromagnetic (which includes optical) or other signals capable of being exchanged by a given communications interface 924. These signals might be provided to communications interface 924 via a channel 928. Channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 908, storage unit 920, media 914, and channel 928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 900 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
receiving first vehicle operating data and associated first environmental data of a plurality of vehicles;
classifying the first vehicle operating data and the first environmental data into a plurality of driver type classifications;
training a control policy model for each driver type classification based on the first vehicle operating data and the first environmental data;
receiving a real-time classification of a target vehicle based on second vehicle operating data and associated second environmental data of the target vehicle; and
output a trained control policy model the to target vehicle based on the real-time classification of the vehicle, wherein the target vehicle is controlled according to the trained control policy model.

2. The method of claim 1, wherein the first vehicle operating data comprises one or more of vehicle speed, lead vehicle speed, and a following distance between the vehicle and the lead vehicle.

3. The method of claim 1, wherein the first environmental data comprises one or more of weather information, time of day information, road type information, road surface condition information, vehicle type information, and a degree of traffic information.

4. The method of claim 1, further comprising:
receiving, from each vehicle of the plurality of vehicles, a subset of the first vehicle operating data and an associated subset of the first environmental data, wherein each subset of the first vehicle operating data and associated subset of the first environmental data correspond in time.

5. The method of claim 1, further comprising:
identifying the plurality of driver type classifications by executing unsupervised learning on the first vehicle operating data and the associated first environmental data.

6. The method of claim 1, further comprises:
for each driver type classification, applying inverse reinforcement learning (IRL) to the first vehicle operating data and the associated first environmental data classified into the respective driver type classification,
wherein training the control policy module is based on the application of the IRL.

7. The method of claim 5, wherein the IRL infers a reward function based on observed demonstrations, wherein the first vehicle operating data and the associated first environmental data classified into the respective driver type classification is the observed demonstrations and the reward function is the control policy model.

8. The method of claim 1, wherein the second vehicle operating data comprises one or more of target vehicle speed, a lead vehicle speed, and a following distance between the target vehicle and the lead vehicle.

9. The method of claim 1, wherein the second environmental data comprises one or more of weather information, time of day information, road type information, road surface condition information, vehicle type information, and a degree of traffic information.

10. The method of claim 1, further comprising:
receiving the second vehicle operating data and the associated second environmental data of the target vehicle; and
classifying the second vehicle operating data and the associated second environmental data into one of the plurality of driver type classifications.

11. The method of claim 1, wherein the first vehicle operating data is first vehicle following data of the plurality of vehicles following a plurality of lead vehicles and the second vehicle operating data is second vehicle following data of the target vehicle following a lead vehicle.

12. A system, comprising:
a memory configured to store machine readable instructions; and
one or more processors that are configured to execute the machine readable instructions stored in the memory for performing a method comprising:
receive first vehicle following data and associated first environmental data of a plurality of vehicles;
classify the first vehicle following data and the first environmental data into a plurality of driver type classifications;
train a cruise control policy model for each driver type classification based on the first vehicle following data and the first environmental data;
receive a real-time classification of a target vehicle based on second vehicle following data and associated second environmental data of a target vehicle; and
output a trained cruise control policy model to the target vehicle based on the real-time classification of the vehicle,
wherein a following distance between the target vehicle and a lead vehicle is controlled according to the trained cruise control policy model.

13. The system of claim 12, wherein the first vehicle operating data comprises one or more of vehicle speed, lead vehicle speed, and a following distance between the vehicle and the lead vehicle, and wherein the first environmental data comprises one or more of weather information, time of day information, road type information, road surface condition information, vehicle type information, and a degree of traffic information.

14. The system of claim 12, wherein the method further comprises:
identifying the plurality of driver type classifications by executing unsupervised learning on the first vehicle operating data and the associated first environmental data.

15. The system of claim 12, wherein the method further comprises:
for each driver type classification, applying inverse reinforcement learning (IRL) to the first vehicle operating data and the associated first environmental data classified into the respective driver type classification,
wherein training the control policy module is based on the application of the IRL.

16. The system of claim 12, wherein the method further comprises:
receiving the second vehicle operating data and the associated second environmental data of the target vehicle; and
classifying the second vehicle operating data and the associated second environmental data into one of the plurality of driver type classifications.

17. A vehicle, comprising:
a plurality of sensors;
a memory configured to store machine readable instructions; and
one or more processors that are configured to execute machine readable instructions stored in the memory for performing a method comprising:
collect, from the plurality of sensors, vehicle operating data and associated environmental data of a plurality of vehicles;
classify, in real-time, the vehicle operating data and the environmental data into a driver type classification;
transmit the real-time driver type classification to a cloud server;
receive, from the cloud server, a trained control policy model based on the real-time driver type classification;
calculate a control policy from the control policy model based on the vehicle operating data; and
control driving of the vehicle based on the calculated control policy.

18. The vehicle of claim 17, wherein the vehicle operating data and associated environmental data are collected in response to user input requesting to activate driving control.

19. The vehicle of claim 17, wherein the method comprises calculating a sequence of control policies from the control policy model based on the vehicle operating data and the environmental data within a time window.

20. The vehicle of claim 17, wherein the method comprises, while driving control is not active, collecting historical vehicle operating data and associated historical environmental data representative of vehicle operating behavior of a user of the vehicle.
